(19) United States
(12) Patent Application Publication
(10) Pub. No.: US 2016/0040833 A1
(43) Pub. Date: Feb. 11, 2016

(54) LIGHTING DEVICE HAVING A VARIABLY ADJUSTABLE LIGHT COLOR

(71) Applicant: ZUMTOBEL LIGHTING GMBH, Dornbirn (AT)

(72) Inventors: Johann ZEHETNER, Dornbirn (AT); David SCHMIDMAYR, Dornbirn (AT); Johannes EDLINGER, Feldkirch (AT)

(21) Appl. No.: 14/782,829

(22) PCT Filed: Apr. 7, 2014
(86) PCT No.: PCT/EP2014/056937

§ 371 Date: Oct. 7, 2015

(30) Foreign Application Priority Data
Apr. 8, 2013 (DE) 10 2013 206 154.4

(51) Int. Cl. F21K 99/00

(52) U.S. Cl. CPC F21K 9/56; F21Y 2101/02

(57) ABSTRACT

Lighting devices having a variably adjustable light color and methods for adjusting the light color of a lighting device are disclosed. In one embodiment, the wavelength of light from a plurality of excitation light sources in a lighting device is converted at least partially by a plurality of color-conversion elements. The color conversion elements are matched to the wavelengths λ₂, λ₃, λ₄, of the excitation light sources. In a second embodiment, the wavelength of light from an excitation light source is converted by way of either a first or second color-conversion element, wherein the color-conversion elements can be switched.

The present invention relates to lighting devices having a variably adjustable light color or light color temperature and to methods for adjusting the light color or light color temperature of a lighting device. In particular, the present invention proposes converting light from exciter light sources of the lighting device and in the process influencing the light color or light color temperature of the lighting device by adjusting specific operational parameters of the lighting device.

It is known from the prior art to vary the light color of a lighting device, in particular an LED luminaire. For this purpose, different colored LEDs are generally arranged physically separated from one another (but on a small area). The LEDs are actuated at different intensities. When viewed from a sufficiently great distance, the mix of the individual light colors of the LEDs acts as a resultant overall light color of the lighting device.

However, in this lighting device, a homogeneous color distribution over the entire emission range of the lighting device can be problematic. A further disadvantage consists in that each of the LEDs of the lighting device has a very narrow-band emission spectrum. Therefore, the lighting device has a comparatively low color rendering index (CRI), which is a measure of the capability of the lighting device to generate different colors with the same color temperature as an ideal or natural light source.

Furthermore, a lighting device is known from the prior art in which blue light of an LED or a laser is influenced by a color conversion layer, wherein the color conversion layer consists of phosphors (for example fluorescent dyes), which emit different colored light. The color conversion layer is either applied directly to the LED or the laser or is arranged at a certain distance therefrom as a so-called “remote phosphor”.

Since the conventionally used phosphors have superimpositions in the absorption and emission spectrum, in addition to the blue light of the LED or the laser a light which is secondarily emitted by one of the phosphors is also absorbed by another of the phosphors (which emits in the longer wavelength range). Therefore, it is necessary to use greater quantities of phosphor than would actually be required for generating the desired light color. In addition, the modeling of the color conversion layer is made more difficult. A further disadvantage consists in that the light color of the lighting device is fixedly preset by the mix ratios of the different phosphors and is not variable.

The present invention is based on the object of improving the abovementioned prior art. In particular, an object of the present invention consists in generating a lighting device having a variably adjustable light color or light color temperature which has a more homogeneous color distribution over its entire emission range. In addition, a further object of the present invention consists in producing a lighting device having a higher CRI. A further object of the present invention consists in reducing the quantity of phosphors used to a required degree. A further object of the present invention consists in providing a lighting device whose phosphors do not permit mutual absorption. A further object of the present invention consists in producing a lighting device for which modeling of a conversion layer is simple. Finally, an object of the present invention consists in improving the efficiency of a lighting device having a variably adjustable light color.

The abovementioned objects are achieved by the lighting devices and methods in accordance with the independent claims. The dependent claims develop the core concepts of the invention in an advantageous manner.

The present invention relates to a lighting device having a variably adjustable light color, said lighting device having: at least a first exciter light source for emitting light of a first wavelength and a second exciter light source for emitting light of a second wavelength, at least one color conversion element for converting the wavelengths of at least some of the light emitted by the exciter light sources, wherein the color conversion element contains at least two color conversion means and each color conversion means is matched to one of the exciter light sources.

The variably adjustable light color in particular also comprises a variably adjustable light color temperature. The lighting device according to the invention overall generates a light which is mixed from some of the light of the exciter light sources, which is not converted, and some of the light which is converted by the color conversion means. A more homogeneous light color distribution can be achieved owing to the plurality of exciter light sources and the color conversion means, preferably in the same number, which are matched to the wavelengths of the exciter light sources. Also owing to the fact that the light generated by the light conversion means is emitted from a homogeneous area, the color distribution of the light of the lighting device is more homogeneous.

For example, the exciter light sources are light sources which emit blue light differently, with the blue light thereof partially being converted into light of other colors, for example into yellow and/or green light, in order to generate, overall, a lighting device which emits white light having a homogeneous but variably adjustable color temperature.

If, for example, broadband dyes with different absorption maxima are used as the at least two color conversion means, color variations of the lighting device can be generated by different excitation wavelengths. The CRI of the lighting device is higher in comparison with the prior art. In addition, different light intensities of the exciter light sources can influence the light emitted by the lighting device. Therefore, special CRI and/or color requirements can be realized with the lighting device according to the invention. The color or color temperature of the light of the lighting device is continuously selectable and variable, for example by means of controlled light intensities of the individual exciter light sources.

Preferably, each color conversion means has an absorption maximum at the wavelength of one of the exciter light sources.

As a result, targeted matching of the color conversion means to the exciter light sources is achieved. Since the absorption spectrum of the color conversion means is preferably not narrow-band, however, color variations can also be achieved by matching of the exciter wavelengths. A high CRI of the lighting device can thus be realized.

Preferably, the wavelength of each exciter light source has an exciting effect selectively for one of the color conversion means so that the selectively excited color conversion means emits light.

Therefore, different or controlled exciter intensities, i.e. light intensities, of the exciter light sources only affect a certain emission bandwidth. As a result, the light color of the lighting device can be adjusted more precisely and continuously.

Preferably, the lighting device is configured to change the color of the light emitted by the lighting device by changing the light intensities of the exciter light sources, preferably by actuating the exciter light sources by means of pulse width modulation (PWM).

Therefore, a simple control mechanism for varying the light color or the light color temperature of the lighting device is provided. By means of PWM, the light color of the lighting device can be adjusted continuously. Ageing phenomena of the lighting device which result in a change in color of the light can also be compensated for easily during operation of the lighting device by virtue of the light intensities of the exciter light sources being adapted.

Preferably, the at least two color conversion means can be contained homogeneously mixed in the color conversion element.

Owing to the fact that all of the color conversion means are arranged together in the color conversion means, a good, homogeneous mixture is already achieved in advance. A homogeneous mixture can generate, for example, an effectively mixed white light which is homogeneous with respect to its color temperature. The color distribution is homogeneous in particular over the entire emission range of the lighting device. Additional measures can also be performed during production of the lighting device which ensure even better mixing of the color conversion means. The mixing can be monitored more or less precisely by machine during production of the color conversion element.

Alternatively, the color conversion element preferably consists of at least two successive layers, wherein each layer contains one of the color conversion means.

Such a color conversion element is easy to produce. The thicknesses of the layers can be the same or different. The thicknesses of the layers can be dimensioned depending on the desired light color and/or depending on the type of exciter light sources used. Each layer can contain distributed color conversion means, wherein the concentration of the color conversion means in the various layers can be the same or different than one another. Concentration gradients within a layer or from one layer to the next are conceivable.

Preferably, the at least two successive layers are arranged in such a way that a layer which contains a color conversion means emitting a relatively long wavelength is arranged closer to the exciter light sources than a layer which contains a color conversion element emitting a relatively short wavelength.

As a result, light which is influenced by the color conversion means of a specific layer can pass substantially uninfluenced through the further following layers. This enables more precise and predictable adjustment of the light color of the lighting device.

Preferably, the at least two successive layers are arranged in such a way that a layer which contains a color conversion means having a relatively broad absorption spectrum is arranged closer to the exciter light sources than a layer which contains a color conversion means having a relatively narrow absorption spectrum.

As a result, a self-absorption effect is reduced. Firstly, the light color can then be adjusted more precisely, and secondly the efficiency of the lighting device is increased.

Preferably, a mirror, preferably an edge filter, which is permeable to the light emitted by the exciter light sources is arranged on that side of the color conversion element which faces the exciter light sources.

In addition, the mirror is intended to reflect the light converted by the color conversion means and emitted in the direction of the exciter light sources. As a result, the efficiency of the lighting device is increased since all of the light is emitted in the desired emission direction. The efficiency of the light generation of the lighting device is therefore increased.

The present invention furthermore relates to a lighting device having a variably adjustable light color, said lighting device having: at least one exciter light source for emitting light of a specific wavelength, at least one color conversion element for converting the wavelength of at least some of the light emitted by the exciter light source, wherein the color conversion element contains at least two color conversion means, which are arranged in such a way that only ever one color conversion means influences the light emitted by the exciter light source, wherein the color conversion element is movable in order to change the color conversion means which influences the light emitted by the exciter light source.

The light color of the lighting device can therefore be adjusted easily and varied during operation of the lighting device. For example, by virtue of a quick change between the at least two color conversion means, for example by moving the color conversion element to and fro, light can be generated which is perceived by an observer as mixed light. By changing the time spans during which the different color conversion means in each case influence the light of the exciter light source, the light color or light color temperature of the lighting device can be varied. A further advantage consists in that modeling of the color conversion means is extremely simple.

By virtue of the movement (for example rotation) of the color conversion element with respect to the exciter light source, it is possible to achieve a situation whereby different light colors are generated sequentially in time but at the same stationary point. The lighting device can therefore operate as a color-variable point light source. As a result, it is possible to use simple and inexpensive optical components, for example lenses, for the spatial distribution of the light. For lighting devices which generate different light colors at different points, on the other hand, usually more complex lens shapes are required in order to achieve a homogeneous spatial distribution of the light. The lighting device according to the invention can therefore be designed easily. This applies to all embodiments of the present invention in which at least one color conversion element is movable.

Preferably, the color conversion element is in the form of a disk and comprises at least two disk segments, wherein each disk segment contains a color conversion means.

Preferably, the disk-shaped color conversion element is rotatable, wherein a rotary angle fixes which of the color conversion means influences the light emitted by the exciter light source.

A rotation of the disk-shaped color conversion element is a simple possibility of changing quickly between the different color conversion means which each influence the light of the exciter light source.

Preferably, the at least two disk segments are separated from one another by mirror layers.

By virtue of the optical separation of the color conversion means in the segments, mutual absorption is ruled out. As a result, it is not necessary to use a greater quantity of color conversion means than is actually required.

Preferably, the diameter of each disk segment is greater, preferably greater by a factor of 2 to 10, than the diameter of the exciter light source.

This prevents the possibility of the light emitted by the exciter light source being simultaneously absorbed or converted by more than one color conversion means.

Preferably, the lighting device is configured to change the color of the light emitted by the lighting device by virtue of a rotation of the disk-shaped color conversion element and activation, matched to the rotation, of the exciter light source.

The light color of the lighting device can therefore be adjusted continuously. The control of the lighting device can be implemented easily.

Preferably, the lighting device is configured to activate, in pulsed fashion, the exciter light source and to control the length of the activation pulses.

As a result, the contribution of each individual color, i.e. the contribution of the light generated by each color conversion means, to the light emitted in total by the lighting device is variably adjustable. As a result, the light color of the lighting device can be varied.

Preferably, an exciter light source is an LED or a laser.

Preferably, the wavelengths of the exciter light sources are in the blue spectral range, and the light emitted by the lighting device is white light.

Preferably, the color conversion means are phosphors and/or quantum dots.

Organic or inorganic phosphors, for example fluorescent dyes, can be used. The phosphors can be dissolved, dispersed, in powder form, in particle form or in cluster form in the color conversion element or the various layers or segments of the color conversion element. In this case, the phosphors can be embedded, for example, in a transparent material, for example a plastic material, or a resin. The phosphors can also be applied, painted on or printed on as a color conversion layer. The quantum dots can be lithographically structured quantum dots, for example. The quantum dots can also be grown quantum dots. A plurality of layers of stacked quantum dots can be used. The various color conversion means can be realized by quantum dots of different sizes or widths. More precise matching to the exciter wavelengths of the exciter light sources is possible for quantum dots.

In addition, the present invention relates to a method for varying the light color of a lighting device, said method having the following steps: generating at least a first light of a first wavelength and a second light of a second wavelength, converting the wavelengths of at least some of the first light and the second light by means of at least two color conversion means, wherein each color conversion means is matched to one of the generated wavelengths, and changing the light intensities of the first light and the second light in order to change the color of the light emitted by the lighting device.

The present invention furthermore relates to a method for varying the light color of a lighting device, said method having the following steps: generating light of a specific wavelength, converting the wavelength of at least some of the generated light by means of a color conversion element which contains at least two color conversion means, wherein only ever one color conversion means influences the generated light, moving the color conversion element in order to change the color conversion means which influences the generated light.

Preferably, owing to the movement of the color conversion element and generation of the light in a manner matched to the movement, the color of the light emitted by the lighting device is changed.

The present invention achieves the abovementioned objects. In particular, the abovementioned disadvantages of the prior art are lessened or entirely eliminated.

The present invention will be described in detail below with reference to the attached figures.

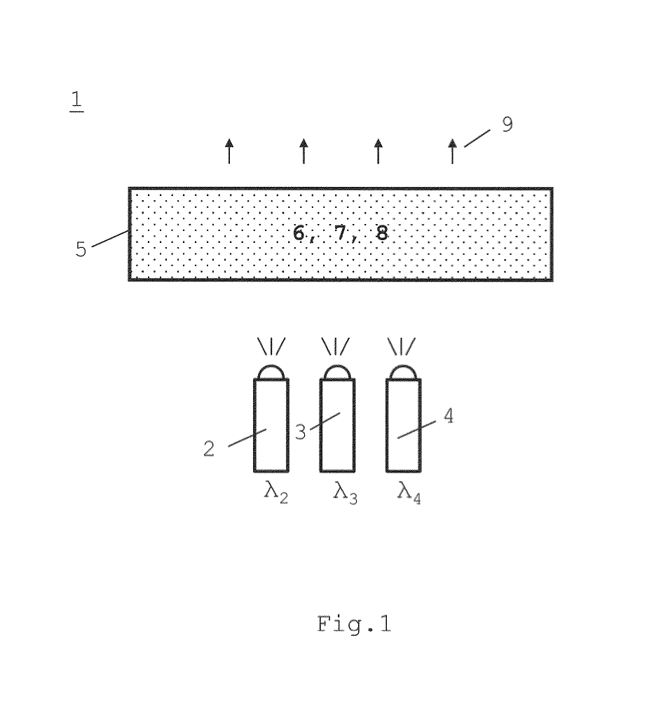

FIG. 1 shows a lighting device in accordance with a first embodiment of the present invention.

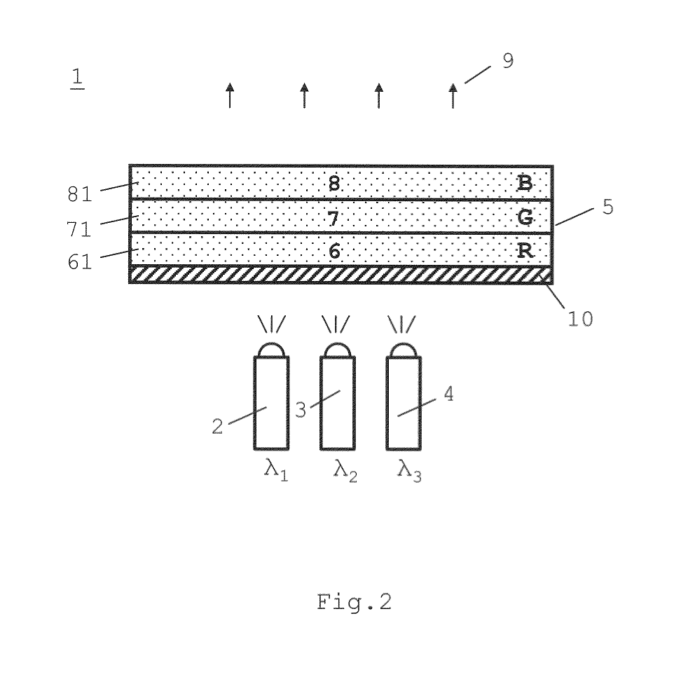

FIG. 2 shows a lighting device in accordance with a second embodiment of the present invention.

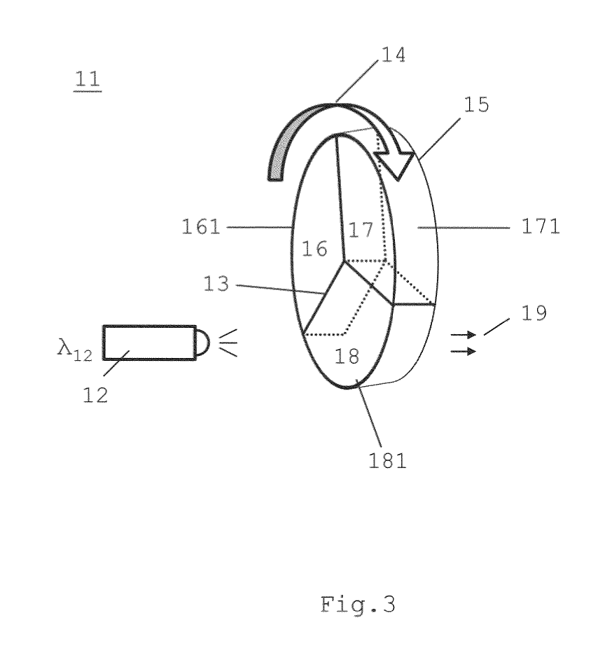

FIG. 3 shows a lighting device in accordance with a third embodiment of the present invention.

FIG. 1 shows a first embodiment of a first basic concept of the present invention. In this case, it is provided that at least two different exciter light sources 2, 3 are used. Advantageously, even three or even more than three exciter light sources 2, 3, 4 are used in the lighting device 1.

Each exciter light source 2, 3, 4 emits light of a different wavelength λ₂, λ₃ and λ₄, respectively. In FIG. 1, a first exciter light source 2 emits light of a first wavelength λ₂, a second exciter light source 3 emits light of a second wavelength λ₃, and a third exciter light source 4 emits light of a third wavelength λ₄. Advantageously, the wavelengths λ₂, λ₃, λ₄ are all in the blue spectral range, i.e. each of the exciter light sources 2, 3, 4 emits light of a different tone of blue. The different exciter light sources 2, 3, 4 can be different LEDs, OLEDs and/or lasers or the like. All exciter light sources 2, 3, 4 are advantageously controllable, preferably at least in respect of the intensity of the light emitted thereby, their switch-on time, in a pulsed operating mode and/or with respect to a clock frequency or a duty factor in a PWM operating mode. Preferably, each exciter light source 2, 3, 4 is individually controllable. The control can in this case be implemented by a control device (not shown) of the lighting device 1, an external wired or wireless control device or by a user via a user interface.

In addition, the lighting device 1 has a color conversion element 5. The light emitted by the exciter light sources 2, 3, 4 is radiated into the color conversion element 5. The color conversion element 5 in FIG. 1 is a color conversion layer, for example. The color conversion element 5 can be applied directly to the exciter light sources 2, 3, 4 or can be arranged at a certain distance from the exciter light sources 2, 3, 4. The color conversion element 5 can be planar or concave or convex. The color conversion element 5 can have the function of a lens, i.e. can focus or diverge light. The color conversion element 5 is suitable for converting the wavelength λ₂, λ₃, λ₄ of at least some of the light emitted by the exciter light sources 2, 3, 4.

For this purpose, the color conversion element 5 is provided with at least two color conversion means 6, 7, which are preferably contained in the color conversion element 5. A color conversion means 6, 7 is excited by light of an exciter light source 2, 3, 4 and thereupon emits light of a different wavelength. At least two color conversion means 6, 7 are contained in the color conversion element 5, in particular when the lighting device 1 has at least two exciter light sources 2, 3. Preferably, a color conversion means 6, 7, 8 is contained in the color conversion element 5 for each exciter light source 2, 3, 4 of the light device. That is to say that the number of exciter light sources 2, 3, 4 and the number of color conversion means 6, 7, 8 is preferably the same. The number of color conversion means 6, 7 can also be greater than the number of exciter light sources, in which case a plurality of color conversion means 6, 7 is assigned to each exciter light source 2, 3, 4. Each color conversion means 6, 7, 8 is preferably matched to one of the exciter light sources 2, 3, 4.

This matching is preferably performed to such an extent that, preferably, each color conversion means 6, 7, 8 can only be used by one of the exciter light sources 2, 3, 4. That is to say that the corresponding color conversion means 6, 7, 8 has, for example, an absorption range which is matched to the wavelength of an assigned exciter light source 2, 3, 4. Ideally, each color conversion means 6, 7, 8 has an absorption maximum at a wavelength λ₂, λ₃, λ₄ of one of the exciter light sources 2, 3, 4. The wavelength λ₂, λ₃, λ₄ of each exciter light source 2, 3, 4 is therefore selective for a color conversion means 6, 7, 8, at least within certain limits. The color conversion means 6, 7, 8 can therefore preferably be excited selectively in order that they emit light.

The color conversion means 6, 7, 8 preferably differ in terms of their absorption maxima, but do not necessarily have narrow-band absorption spectra. The exciter light sources 2, 3, 4 are adjusted in a suitable manner to the absorption maximum of the absorption spectrum of the corresponding color conversion means 6, 7, 8. The narrower the absorption spectrum, the better matching to the exciter light source can be achieved. The broader the absorption spectrum, the more color variation is possible.

The color conversion means 6, 7, 8 are preferably phosphors, for example phosphor or fluorescent dyes. The color conversion means 6, 7, 8 can also be quantum dots. Quantum dots can be matched very precisely to the exciter wavelengths since their energy levels can be adjusted in a targeted manner. A color conversion means 6, 7, 8 therefore preferably consists of a multiplicity of phosphor particles and/or quantum dots. The phosphors or quantum dots of the different color conversion means 6, 7, 8 are different from one another, preferably at least in terms of an excitation wavelength or an absorption maximum.

The light emitted overall by the color conversion element 5 is extremely homogeneous owing to the homogeneous area itself and can correspond to the light 9 emitted overall by the lighting device 1. The emitted light 9 can be changed, for example directed, focused, converged, diverged or scattered, additionally by suitable means of the lighting device 1 in advance, however. The emitted light 9 is at least a superimposition of the light of the exciter light sources 2, 3, 4 and the light which is emitted by the plurality of color conversion means 6, 7, 8 of the color conversion element 5. The result of this is that the emitted light 9 is a mixed light and a light color of the lighting device is achieved from a mixture of a plurality of individual colors.

In FIG. 1, the color conversion means 6, 7, 8 are mixed homogeneously in the color conversion element 5. The homogeneous mixing of the plurality of color conversion means 6, 7, 8 can already be performed in advance, i.e. during manufacture of the color conversion element 5. Accordingly, for example, a very thoroughly mixed white light can be generated which is emitted very homogeneously over the entire emission range of the lighting device 1 and in particular has a uniform color temperature.

By virtue of individual actuation of the exciter light sources 2, 3, 4, for example, the intensity of the light from each exciter light source 2, 3, 4 can be influenced. Different light intensities, i.e. different excitation intensities, can therefore be adjusted for selective excitation of the various color conversion means 6, 7, 8. Different excitation intensities therefore only have an effect on a certain emission bandwidth, as a result of which it is possible for there to be a direct influence on the light 9 emitted by the lighting device 1. In particular, the exciter light sources 2, 3, 4 can be actuated by PWM in order to influence the light emission of the lighting device 1. In particular, the color or the color temperature of the light 9 emitted by the lighting device 1 can be adjusted or varied during operation of the lighting device 1.

FIG. 2 shows a second embodiment of the first basic concept of the present invention. The second embodiment can have all of the features of the first embodiment apart from the fact that the lighting device 1 of the second embodiment has a color conversion element 5, in which the different color conversion means 6, 7, 8 are not mixed homogeneously, but rather said color conversion element comprises at least two successive layers 61, 71, wherein each layer contains one of the at least two color conversion means 6, 7. Preferably, even three successive layers 61, 71, 81 are used, or even more than three successive layers are used, in order to construct the color conversion element 5. The color conversion means 6, 7, 8 can again be phosphors and/or quantum dots. The color conversion element 5 can consist of three layers 61, 71, 81 applied one on top of the other. The layers 61, 71, 81 can be adhesively bonded to one another, for example. The color conversion element 5 can also consist of one piece, but comprise three successive regions, in which different color conversion means 6, 7, 8 are contained. The different color conversion means 6, 7, 8 can emit, for example, red (R), green (G) and blue (B) light, respectively, as shown in FIG. 2. In combination with three exciter light sources 2, 3, 4 which all emit light of a different tone of blue, overall a thoroughly mixed, i.e. homogeneous, white light 9 is achieved.

In the second embodiment shown in FIG. 2, it should be noted that preferably a color conversion means 6 which emits light of a relatively long wavelength or with the lowest energy is arranged closest to the exciter light sources 2, 3, 4, i.e. is arranged at the lowermost point in FIG. 2. A color conversion means 7 which emits light of a relatively short wavelength or with a relatively high level of energy is preferably arranged further removed from the exciter light sources 2, 3, 4, i.e. above the abovementioned color conversion means 6 in FIG. 2. As a result, light which is influenced by a specific color conversion means 6 can pass substantially uninfluenced through the successive, further removed layers with different color conversion means 7, 8. As the distance from the exciter light sources 2, 3, 4 increases, a layer 61, 71, 81 therefore preferably contains a color conversion means 6, 7, 8 which emits longer light wavelengths. The layers 61, 71, 81 are preferably arranged in such a way that a layer 61 with a color conversion means 6 having a relatively broad absorption spectrum is arranged closer to the excitation light sources 2, 3, 4 than a layer 71 having a color conversion means 7 having a relatively narrow absorption spectrum. Owing to the abovementioned advantageous arrangement of the layers 61, 71, 81, a self-absorption effect is prevented or at least reduced.

FIG. 2 also shows that a mirror 10, preferably an edge filter, which is permeable to wavelengths of the light of the exciter light sources 2, 3, 4, can be arranged between the exciter light sources 2, 3, 4 and the color conversion element 5. Therefore, the mirror 10 allows the light emitted by the exciter light sources 2, 3, 4 to pass through but reflects light which is emitted by the color conversion means 6, 7, 8 in the direction of the exciter light sources 2, 3, 4 and deflects this light in the direction of the light 9 emitted by the lighting device 1. As a result, the effectiveness of the lighting device 1 is increased. The efficiency of the lighting device 1 can thereby be increased. Such a mirror can also be used for the first embodiment shown in FIG. 1.

FIG. 3 shows a third embodiment of a second basic concept of the present invention. Features of the first two embodiments can also be provided for the third embodiment as long as there is no contradiction. The lighting device 11 shown in FIG. 3 comprises only a single exciter light source 12, which emits light of a specific wavelength λ₁₂. In turn, the lighting device 11 has a color conversion element 15. The color conversion element 15 is arranged in such a way that the light emitted by the exciter light source 12 is radiated onto said color conversion element. The light 19 emitted by the lighting device 11 can be the light which is emitted ultimately by the color conversion element 15. The emitted light 19 can be varied or influenced further still in advance, however, as for the first two embodiments.

The color conversion element 15 has at least two color conversion means 16, 17. These color conversion means 16, 17 are preferably arranged in separate regions of the color conversion element 15 so that, given a specific orientation of the exciter light source 12 with respect to the color conversion element 15, only ever one of the color conversion means 16, 17 influences the light emitted by the exciter light source 12. For this purpose, it is advantageous that the diameter of the exciter light source 12 is markedly smaller than the diameter of the region in which one of the color conversion means 16 or 17 is arranged. The color conversion element 15 can consist of at least two segments 161, 171, for example, whose diameter is in each case greater by a factor of 2 to 10, preferably 4 to 6, than the diameter of the exciter light source 12.

The color conversion element 15 is preferably arranged movably in the lighting device 11, with the result that, by virtue of a movement of the color conversion element 15, at least either a first color conversion means 16 or a second color conversion means 17 is arranged in front of the exciter light source 12 in such a way that only this color conversion means 16, 17 influences the light emitted by the exciter light source 12. The invention naturally also comprises three or more color conversion means 16, 17, 18 in three or more different segments 161, 171, 181. By virtue of the movement of the color conversion element 15 and simultaneous matched activation of the exciter light source 12, the light emission of the lighting device 11 can be influenced during operation, and in particular the color or the color temperature of the light 19 emitted by the lighting device 11 can be varied during operation. Ideally, in this case the color conversion element 15 is moved, for example moved to and fro, so quickly that a first color conversion means 16 or a second color conversion means 17 influences the light emitted by the exciter light source 12 in quickly alternating fashion. The change is preferably so quick that the light 19 emitted in total is perceived by an observer as a mixed light.

FIG. 3 shows that the color conversion element 15 can be a disk-shaped element which is rotatable, for example. The disk-shaped color conversion element 15 preferably has three segments 161, 171, 181, which each contain a different color conversion means 16, 17 and 18, respectively. The segments 161, 171, 181 of the color conversion element 15 are preferably separated from one another by a mirror layer 12.

In FIG. 3, a rotary angle 14 of a rotation of the color conversion element 15 fixes which of the color conversion means 16, 17, 18 is arranged with respect to the exciter light source 12 in such a way that only this color conversion means 16, 17, 18 influences the light emitted by the exciter light source 12. The disk-shaped color conversion element 15 can be rotated, for example, at a rotation frequency in the region of preferably 50 Hz or more, more preferably 50-200 Hz, further preferably still approximately 100 Hz, in order to achieve a quick change of the color conversion means 16, 17, 18 which influences the light from the exciter light source 12.

The exciter light source 12 can also be operated in pulsed fashion in a manner matched to the rotation of the color conversion element 15, wherein the pulses can have different lengths and/or different amplitudes, i.e. can correspond to a different light intensity. By virtue of the rotation of the color conversion element 15, the different color conversion means 16, 17, 18 move past the exciter light source 12 successively. If the exciter light source 12 is additionally operated in controlled and pulsed fashion, the contribution of the individual light colors which are generated by the individual color conversion means 16, 17, 18 is variably adjustable, with the result that the color of the light 19 emitted overall can be varied. The respective component of the corresponding color conversion means 16, 17, 18 can be selected such that, by virtue of a change in the mentioned parameters, a desired mixed light, preferably white light, is emitted by the lighting device 11.

The present invention also relates to methods which can be implemented for adjusting or varying the light color of the lighting devices 1 and 11. In particular, in this case a method is proposed for the first basic concept of the present invention, in which method the intensities of the exciter light sources 2, 3, 4 are controlled individually and with monitoring, preferably by means of PWM. For the second basic concept of the present invention, a method is proposed in which the movement, for example the rotational speed or the rotary angle of the color conversion element 15, is controlled with matching to the activation, preferably pulsed activation, of the exciter light source 12. In particular, in this case a pulse width or a pulse amplitude of the exciter light source 12 can be adjusted corresponding to the adjusted rotary angle or corresponding to a rotational speed of the color conversion element 5.

The present invention therefore provides a lighting device 1, 11 having a variable light color and a method for varying the light color. By means of the present invention, specific CRI and/or color requirements placed on the lighting device 1, 11 can be realized. Ageing phenomena of the lighting device 1, 11 can be compensated for, for example, by varying the intensities of the exciter light sources 2, 3, 4, 12.

Continuously adjustable light colors can be realized. In addition, the use of relatively large quantities of phosphor can be avoided as necessary. Overall, therefore, a marked improvement over the prior art is achieved.

1. A lighting device having a variably adjustable light color, said lighting device comprising:
at least a first exciter light source for emitting light of a first wavelength (λ₂) and a second exciter light source for emitting light of a second wavelength (λ₃),
at least one color conversion element for converting the wavelengths (λ₂, λ₃) of at least some of the light emitted by the exciter light sources,
wherein the color conversion element contains at least two color conversion means and each color conversion means is matched to one of the exciter light sources.

2. The lighting device as claimed in claim 1, wherein
each color conversion means has an absorption maximum at the wavelength (λ₂, λ₃) of one of the exciter light sources.

3. The lighting device (1) as claimed in claim 1, wherein
the wavelength (λ₂, λ₃) of each exciter light source has an exciting effect selectively for one of the color conversion means so that the selectively excited color conversion means emits light.

4. The lighting device as claimed in claim 1, which is configured to change the color of the light emitted by the lighting device by changing the light intensities of the exciter light sources, preferably by actuating the exciter light sources by means of pulse width modulation.

5. The lighting device as claimed in claim 1, wherein
the at least two color conversion means are contained homogeneously mixed in the color conversion element.

6. The lighting device as claimed in claim 1, wherein
the color conversion element consists of at least two successive layers, wherein each layer contains one of the color conversion means.

7. The lighting device as claimed in claim 6, wherein
the at least two successive layers are arranged in such a way that a layer which contains a color conversion means emitting a relatively long wavelength (R) is arranged closer to the exciter light sources than a layer which contains a color conversion element emitting a relatively short wavelength (G).

8. The lighting device as claimed in claim 6, wherein
the at least two successive layers are arranged in such a way that a layer which contains a color conversion means having a relatively broad absorption spectrum is arranged closer to the exciter light sources than a layer which contains a color conversion means having a relatively narrow absorption spectrum.

9. The lighting device as claimed in claim 1,
wherein a mirror, preferably an edge filter, which is permeable to the light emitted by the exciter light sources is arranged on that side of the color conversion element which faces the exciter light sources.

10. A lighting device having a variably adjustable light color, said lighting device having
at least one exciter light source for emitting light of a specific wavelength (λ₁₂),
at least one color conversion element for converting the wavelength (λ₁₂) of at least some of the light emitted by the exciter light source,
wherein the color conversion element contains at least two color conversion means, which are arranged in such a way that only ever one color conversion means influences the light emitted by the exciter light source,
wherein the color conversion element is movable in order to change the color conversion means which influences the light emitted by the exciter light source.

11. The lighting device as claimed in claim 10, wherein
the color conversion element is in the form of a disk and comprises at least two disk segments,
wherein each disk segment contains a color conversion means.

12. The lighting device as claimed in claim 11,
wherein the disk-shaped color conversion element is rotatable,
wherein a rotary angle fixes which of the color conversion means influences the light emitted by the exciter light source.

13. The lighting device as claimed in claim 11,
wherein the at least two disk segments are separated from one another by mirror layers.

14. The lighting device as claimed in claim 11, wherein
the diameter of each disk segment is greater, preferably greater by a factor of 2 to 10, than the diameter of the exciter light source.

15. The lighting device as claimed in claim 12, which is configured to change the color of the light emitted by the lighting device by virtue of a rotation of the disk-shaped color conversion element and activation, matched to the rotation, of the exciter light source.

16. The lighting device as claimed in claim 15, which is configured to activate, in pulsed fashion, the exciter light source and to control the length of the activation pulses.

17. The lighting device as claimed in claim 1, wherein
an exciter light source is an LED or a laser.

18. The lighting device as claimed in claim 1,
wherein the wavelengths (λ₂, λ₃, λ₁₂) of the exciter light sources are in the blue spectral range, and
the light emitted by the lighting device is white light.

19. The lighting device as claimed in claim 1, wherein
the color conversion means are phosphors and/or quantum dots.

20. A method for adjusting the light color of a lighting device, said method having the following steps:
generating at least a first light of a first wavelength (λ₂) and a second light of a second wavelength (λ₃),
converting the wavelengths (λ₂, λ₃) of at least some of the first light and the second light by means of at least two color conversion means, wherein each color conversion means is matched to one of the generated wavelengths (λ₂, λ₃), and
changing the light intensities of the first light and the second light in order to change the color of the light emitted by the lighting device.

21. A method for adjusting the light color of a lighting device, said method having the following steps:
generating light of a specific wavelength (λ₁₂),
converting the wavelength (λ₁₂) of at least some of the generated light by means of a color conversion element which contains at least two color conversion means, wherein only ever one color conversion means influences the generated light, and
moving the color conversion element in order to change the color conversion means which influences the generated light.

22. The method as claimed in claim 19, wherein
owing to the movement of the color conversion element and generation of the light in a manner matched to the movement, the color of the light emitted by the lighting device is changed.
